(19) United States
(12) Patent Application Publication
(10) Pub. No.: US 2025/0207784 A1
(43) Pub. Date: Jun. 26, 2025

(54) COOKING APPLIANCE WITH A FILTER

(71) Applicant: WHIRLPOOL CORPORATION, BENTON HARBOR, MI (US)

(72) Inventors: TUSHAR A. KALBANDE, PUNE (IN); SARANG H. LOKAKSHA, PUNE (IN); YOGESH Vasant SONONE, PUNE (IN)

(21) Appl. No.: 18/985,501

(22) Filed: Dec. 18, 2024

Related U.S. Application Data
(60) Provisional application No. 63/613,314, filed on Dec. 21, 2023.

(51) Int. Cl. F24C 15/20; B01D 39/20; B01D 46/52; B01D 46/64; F24C 15/32

(52) U.S. Cl. CPC F24C 15/2035; B01D 39/2062; B01D 46/521; B01D 46/64; F24C 15/322

(57) ABSTRACT

A cooking appliance includes a cooking chamber and a convection fan to circulate an airflow therethrough via a hinged baffle. An air filter is in fluid communication with the fan to filter the airflow. The hinged baffle supports the filter elements and is selectively moveable between a closed position covering the air filter and an opened position exposing the air filter.

### CROSS-REFERENCE TO RELATED APPLICATION(S)

This application claims priority to and the benefit of U.S. Provisional Application No. 63/613,314, filed Dec. 21, 2023, the entirety of which is incorporated herein by reference.

### TECHNICAL FIELD

Aspects as described herein relate to a household appliance such as an oven, and more particularly to an oven having a convection fan.

### BACKGROUND

Cooking appliances such as ovens typically include a cooking chamber in which food is heated using various heat sources such as gas or electricity. Heat can be generated based on a flame, electric conduction, electric induction, microwaves, and the like. In some cases, a convection fan is used to provide a flow of heated air into the cooking chamber.

### BRIEF SUMMARY

In one aspect, the disclosure relates to a cooking appliance comprising a chassis defining a cooking chamber and having an access opening; a heating element operably coupled with the cooking chamber; a convection fan in fluid communication with the cooking chamber; and an air filter assembly in fluid communication with the convection fan. The air filter assembly comprises a hinged baffle disposed in the cooking chamber in fluid communication with the convection fan, and a set of filter stages positioned between the convection fan and the hinged baffle. The hinged baffle is selectively moveable between a closed position and an opened position.

In another aspect, the disclosure relates to an air filter assembly for a cooking appliance having a chassis defining a cooking chamber, and a convection fan in fluid communication with the cooking chamber. The air filter assembly comprises a hinged baffle disposed in the cooking chamber and selectively moveable between a closed position in fluid communication with the convection fan, and an opened position, and a set of filter stages positioned between the convection fan and the hinged baffle.

### BRIEF DESCRIPTION OF THE DRAWINGS

In the drawings:

FIG. 1 illustrates a perspective view of a cooking appliance in accordance with a non-limiting aspect of the present disclosure.

FIG. 2 illustrates an isometric view of the oven of FIG. 1 with the door removed for clarity in accordance with a non-limiting aspect of the present disclosure.

FIG. 3 is a schematic diagram of an exemplary control system utilized in the oven of FIG. 1, in accordance with a non-limiting aspect of the present disclosure.

FIG. 4 is a perspective exploded view of the convection fan and the air filter assembly, in accordance with a non-limiting aspect of the present disclosure.

FIG. 5A is a schematic diagram of a cross section of the convection fan and the air filter assembly of FIG. 4 with the heating element removed for clarity and the baffle in an open position, in accordance with a non-limiting aspect of the present disclosure.

FIG. 5B is a schematic diagram of a cross section of the convection fan and the air filter assembly of FIG. 4 with the heating element removed for clarity and the baffle in a closed position, in accordance with a non-limiting aspect of the present disclosure.

### DETAILED DESCRIPTION

In describing aspects illustrated in the drawings, specific terminology will be resorted to for the sake of clarity. However, it is not intended that the aspects be limited to the specific terms so selected and it is to be understood that each specific term includes all technical equivalents that operate in a similar manner to accomplish a similar purpose. For example, the words “connected,” “attached,” “coupled,” and “supported” and variations thereof herein are used broadly and encompass direct and indirect connections, attachments, couplings, and supports. In addition, the terms “connected,” “coupled,” etc. and variations thereof are not restricted to physical or mechanical connections, couplings, etc. as all such types of connections should be recognized as being equivalent by those skilled in the art.

As used herein, the term “set” or “a set” of elements can be any non-zero number of elements, including only one. The exemplary drawings are for purposes of illustration only and the dimensions, positions, order and relative sizes reflected in the drawings attached hereto can vary.

Additionally, as used herein, a “controller”, or “controller module” can include a component configured or adapted to provide instruction, control, operation, or any form of communication for operable components to affect the operation thereof. A processor or controller module can include any known processor, microcontroller, or logic device, including, but not limited to: Field Programmable Gate Arrays (FPGA), an Application Specific Integrated circuit (ASIC), a Proportional controller (P), a Proportional Integral controller (PI), a Proportional Derivative controller (PD), a Proportional Integral Derivative controller (PID controller), a hardware-accelerated logic controller (e.g. for encoding, decoding, transcoding, etc.), the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a processor or controller module can also include a data storage component accessible by the processor, including memory, whether transient, volatile or non-transient, or non-volatile memory.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to affect a functional or operable outcome, as described herein. In another non-limiting example, a control module can include comparing a first value with a second value and operating or controlling operations of additional components based on the satisfying of that comparison. For example, when a sensed, measured, or provided value is compared with another value, including a stored or predetermined value, the satisfaction of that comparison can result in actions, functions, or operations controllable by the controller module.

As used herein, the term “satisfies” or “satisfaction” of the comparison is used herein to mean that the first value satisfies the second value, such as being equal to or less than the second value or being within a predetermined value range of the second value. It will be understood that such a determination may easily be altered to be satisfied by a positive/negative comparison or a true/false comparison. Example comparisons can include comparing a sensed or measured value to a threshold value or threshold value range.

As used herein, the term “fan” or “convection fan” refers to an apparatus having rotating blades or members, for example, a fan that operates to create an airflow or current of air for ventilation. Such fans can have a single speed of rotation of the blades or can have a speed of rotation of the blades that is selectable or adjustable between at least a low speed and a high speed. As used herein, the term “fan speed” refers to the speed of rotation of the rotating blades of the blower and can include a rotational speed of zero.

The disclosure relates to household appliances having a convection fan. While the disclosure is written in the context of an oven with a convection fan, the disclosure is applicable to any type of appliance with a fan, including, without limitation, a refrigerator, microwave, toaster oven, dishwasher.

Many known ovens include a heat source, such as a flame, to generate heat, and a fan, such as a convection fan, for circulating heated air within a cooking chamber of the oven. For example, a conventional convection oven includes a convection fan which typically operates in a single direction to circulate air within the oven during convection cooking. As a consequence of the generated heat, cooking by-products such as water vapor, oil mist, combustion gases (e.g., smoke), airborne grease, and other particulates, are generated within the cooking chamber. These cooking by-products can result in unpleasant odors. Additionally, some of the oil, grease and particulates can adhere to inner walls of the cooking chamber and/or enter the fan.

Aspects as described herein can provide a cooking appliance having a conventional centrifugal convection fan cooperative with a novel baffle and filter assembly to more efficiently filter grease, particulates, odor and smoke from the convection oven airflow than conventional arrangements. The baffle is in fluid communication with the airflow. The filter assembly can be removably coupled to, or retained by, the baffle in registry with the airflow. The filter assembly includes three successive filtration layers or elements. The first filter element can act as a “pre-filter” to capture or filter grease or smoke from the airflow. The second filter element can include a HEPA filter, for example to capture or filter food particles having a size of 0.3 microns or greater. The third filter element can include activated carbon to filter or capture odors present in the airflow. It is contemplated that the filter assembly can operate at temperatures up to 360 degrees Celsius. It is further contemplated that the filter assembly, or filter elements, will need periodic replacement or servicing (e.g., twice a year). Aspects as described herein enable easy (e.g., tool-free) access to the filter assembly for replacement or service. For example, as described herein, the baffle can be arranged as a hinged cover, to cover or prevent access to the filter assembly. The baffle can be retained in a closed (e.g., operating) position by fasteners such as wing nuts. The wing nuts can be loosened or removed by hand or general tools and the baffle can then be pivoted from the closed position to an open (e.g., servicing) position, for example at a predetermined opening angle, to enable user access to the filter assembly. The filter assembly can be released from a retained position (e.g., by rotating the filter assembly) and removed from the baffle. A new, or serviced, filter assembly can be installed in the reverse order of removal, for example, by inserting a new filter assembly into the baffle, engaging the filter assembly into a retained position (e.g., by rotating the filter assembly). The baffle can then be rotated to the closed position and retained using the fasteners.

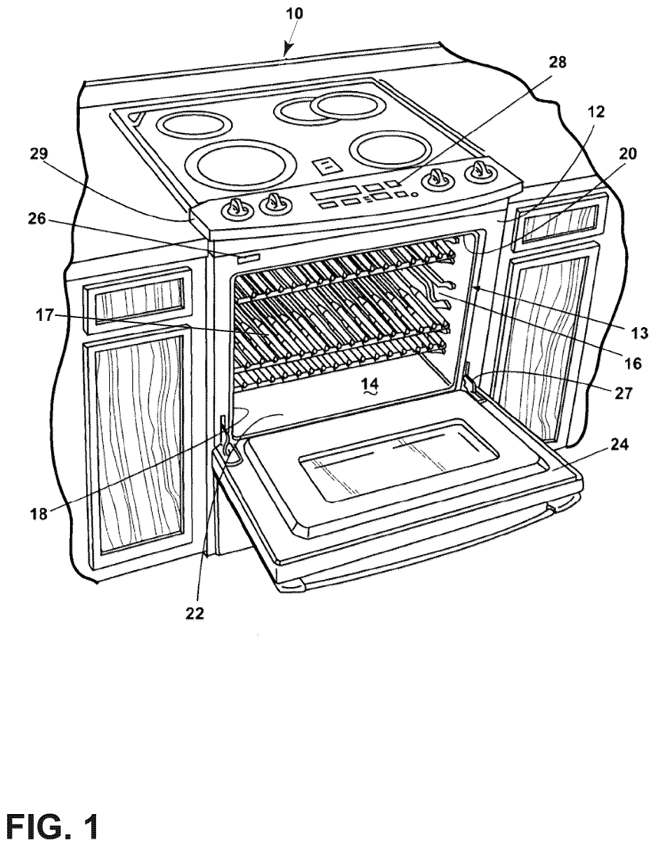

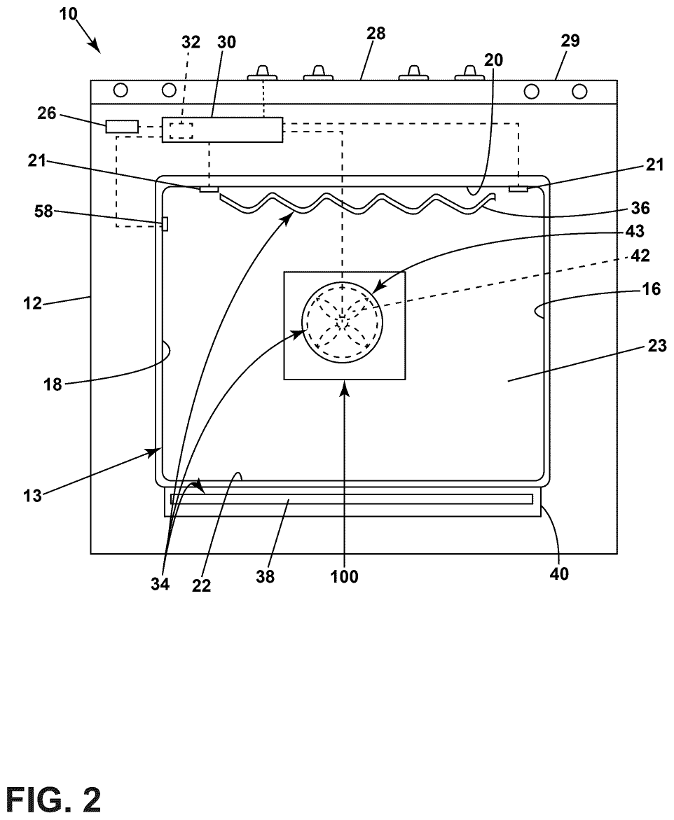

Referring to FIG. 1, a perspective view of an exemplary cooking appliance is shown in the form of an oven 10 and can be used for cooking one or more food items. The oven 10 comprises a cabinet 12 with an open-face housing 13 having a pair of spaced side walls 16, 18 joined by a top wall 20, a bottom wall 22, and a rear wall 23 (shown in FIG. 2) to define a treating chamber or cooking chamber 14. A closure member can be operably coupled to the cabinet 12 to selectively close the open-face housing 13. In the illustrated example, a door 24 pivotable at a hinge 27 selectively closes the cooking chamber 14. A first sensor 26 can be provided to detect a position of the door 24, and to provide an output signal indicative of the position of the door 24. It is contemplated that the first sensor 26 can provide a signal indicative of an opened position of the door 24, a closed position of the door 24, or both. When the door 24 is in the opened position, a user can access the cooking chamber 14. When the door 24 in the closed position, the door 24 prevents access to the cooking chamber 14 and seals the cooking chamber 14 from the external environment. A set of removeable racks 17 or shelves for supporting food items or cookware (e.g., a pot) can extend between the side walls 16, 18.

The oven 10 can further include a console 29 with a control panel 28 having a user interface accessible to the user for inputting desired cooking parameters, such as temperature and time, of manual cooking cycles or for selecting automated cooking cycles. The user interface can comprise, for example, a push button, a rotatable knob, a touch pad, a touch screen, or a voice command unit.

Referring to FIG. 2, an isometric view of the oven 10 is illustrated with the door 24 and racks 17 omitted for clarity. The oven 10 can further include a controller 30, a second sensor 58, a set of lights 21, a heating system 34 having a convection fan 42, and an air filter assembly 100.

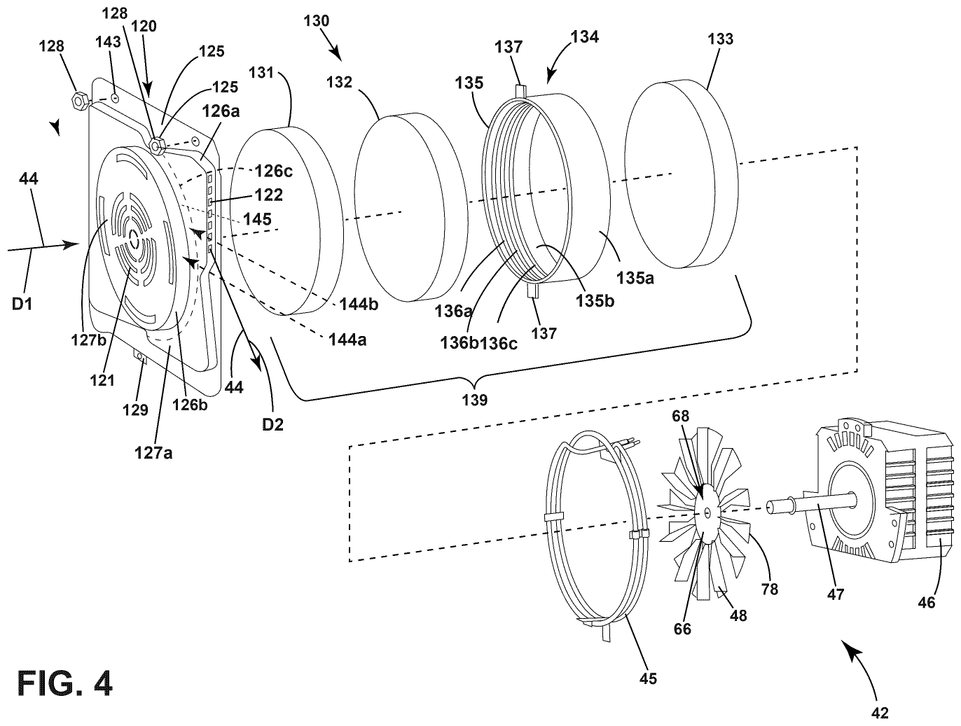

The heating system 34 can include an upper heating element 36, commonly referred to as a broiler, and a lower heating element 38. FIG. 2 depicts a non-limiting aspect in which the lower heating element 38 is hidden or mounted beneath the bottom wall 22 in a heating element housing 40. Heat from the lower heating element 38 conducts through the bottom wall 22 and into the cooking chamber 14. In other non-limiting aspects, the lower heating element 38 can be mounted inside the cooking chamber 14. Further, the upper and lower heating elements 36, 38 can be mounted at the side walls 16, 18 of the cooking chamber 14. In non-limiting aspects, each of the upper and lower heating elements 36, 38 can be a gas heater, an electric heater, or combinations thereof. Regardless of the location of the upper and lower heating elements 36, 38, the heating system 34 further includes the convection fan 42 operative to circulate air and steam, when present, within the cooking chamber 14. The convection fan 42 can be any suitable fan and can be mounted in any suitable location of the cooking chamber 14, such as in, or mounted to, the rear wall 23. In other aspects, the convection fan 42 can be disposed outside the cooking chamber 14 on an opposing side of the rear wall 23 as illustrated. For example, the rear wall 23 can define an aperture or fan inlet 43 therethrough. The convection fan 42 can be arranged in fluid communication with the fan inlet 43. The heating system 34 can include a convection heating element (shown in FIG. 4) located near the convection fan 42 to ensure that the convection fan 42 circulates heated air. The particular type of heating system is not germane to the invention; the heating system 34 shown and described herein is for illustrative purposes only and is not meant to limit the scope of the disclosure. The air filter assembly 100 is arranged between the convection fan 42 and the cooking chamber 14.

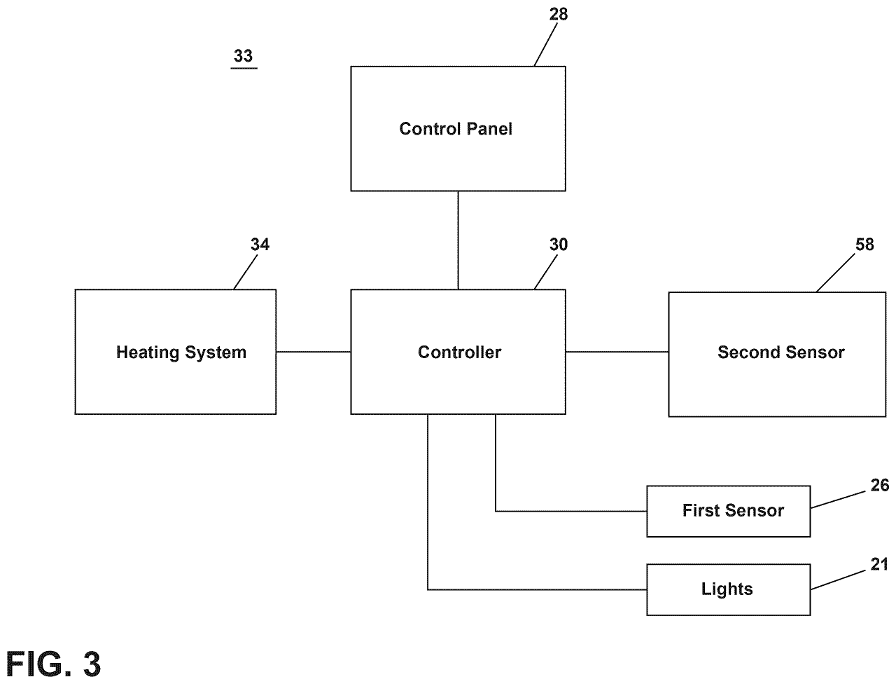

The controller 30 is located in the cabinet 12 and communicatively coupled to the control panel 28. The controller 30 can be part of a control system (shown in FIG. 3) of the oven 10. The controller 30 can be, for example, a PID controller or any other suitable controller. The controller 30 stores data (e.g., in a memory), such as default cooking parameters, the manually input cooking parameters, and programs for the automated cooking cycles, receives input from the control panel 28 and the second sensor 58, and sends output to the control panel 28 for displaying a status of the oven 10 or otherwise communicating with the user. Additionally, the controller 30 can include a timer 32 for tracking time during manual and automated cooking cycles.

The second sensor 58 can be disposed in the cooking chamber 14, for example on one of the side walls 16, 18. The second sensor 58 can be communicatively coupled to the controller 30. The second sensor 58 need not be a single sensor but can alternatively be multiple different sensors for making any desired measurements of the cooking chamber 14. Exemplary sensors can include but are not limited to a temperature sensor, an infrared sensor, a food temperature probe, or a rack sensor. The lights 21 can be provided on the top wall 20 for illuminating the cooking chamber 14. While shown as positioned in the top wall 20, the lights 21 can be positioned anywhere to suitably illuminate the cooking chamber 14.

FIG. 3 is a block diagram that schematically illustrates an exemplary control system 33 of the oven 10. The control system 33 can include the controller 30, which operably communicates with the control panel 28, as described above, first sensor 26, the second sensor 58, the lights 21, and the heating system 34. The controller 30 is configured to instruct the heating system 34 to activate or deactivate the upper heating element 36, the lower heating element 38, the convection fan 42, and the convection heating element (FIG. 4), either all together, individually, or in groups, and provides instructions regarding the desired temperature of the cooking chamber 14 and the rate at which the heating system 34 heats the cooking chamber 14. In some aspects, the controller 30 can be further configured to control a fan speed, a direction of rotation, or both, of the convection fan 42.

FIG. 4 is an exploded view of the convection fan 42 and the air filter assembly 100. The convection fan 42 includes a motor 46, which can be operably coupled to the controller 30 (shown in FIG. 2). A rotatable shaft 47 extends from the motor 46 and a blade assembly 48 may be mounted to the rotatable shaft 47. In non-limiting aspects, the, motor 46 can be a permanent split capacitor (PSC) motor. In some aspects, the motor 46 can be reversible in that the motor 46 can alternately drive the blade assembly 48 in a clockwise and in a counter-clockwise direction. In some non-limiting aspects, the motor 46 can be a two-pole PSC motor configured to rotate the rotatable shaft 47 at speeds up to 3600 revolutions per minute (rpm) in both a clockwise direction and/or a counter-clockwise direction. In other non-limiting aspects, the motor 46 can be a reversible motor other than a PSC motor.

The blade assembly 48 can include a set of radially extending fan blades 78 extending from a circular central section 66. The central section 66 includes an opening 68 sized to engageably receive the rotatable shaft 47 therethrough. Each fan blade 78 extends radially outward, is substantially planar, and pushes air when the blade assembly 48 is rotated. In non-limiting aspects blade assembly 48 can be fabricated from a single piece of sheet steel.

In non-limiting aspects, the convection fan 42 can include a convection heating element 45 (e.g., a heat source). In one non-limiting instance, the convection heating element 45 can be a 2500 W heating element. In non-limiting aspects, the convection heating element 45 extends circumferentially around the blade assembly 48. In other aspects the convection fan 42 does not include the convection heating element 45 (e.g., in a pseudo-convection oven). An airflow 44 can be operatively created or moved by the convection fan 42.

A baffle 120, a filter casing 134, and a set of filter stages 130 can be included in the air filter assembly 100. In non-limiting aspects, the set of filter stages 130 can include a first filter element 131, a second filter element 132, and a third filter element 133. The filter casing 134 can support the set of filter stages 130. For example, the filter casing 134 can circumferentially surround or enclose the first filter element 131, the second filter element 132, and the third filter element 133. Although it will be understood that this need not be the case. When so arranged, the filter casing 134 and the set of filter stages 130 can collectively define a cartridge 139. The first filter element 131, the second filter element 132, and the third filter element 133 are positioned to be directly within the airflow 44 (e.g., in registry with the convection fan 42) to filter the airflow 44. For example, the filter casing 134 can include an annular first leg 135. The annular first leg 135 can include an annular, radially outer first face 135a and an opposing radially inner second face 135b. In non-limiting aspects, the filter casing 134 can define a set of first retention features 137. For example, in non-limiting aspects, the first retention features 137 can be a set of tabs radially extending from the annular first leg 135 of the filter casing 134. The first retention features 137 can be circumferentially spaced from each other. In other non-limiting aspects, the first retention features 137 can include a set of slots or grooves (not shown) defined on the outer first face 135a.

In non-limiting aspects, the radially inner second face 135b of the annular first leg 135 can define a set of annular grooves 136a, 136b, 136c. The first filter element 131, the second filter element 132, and the third filter element 133 can each be circumscribed by the filter casing 134 and received on a respective annular groove 136a, 136b, 136c. In this way, the filter casing 134 can limit or arrest a radial movement or an axial movement, or both, of the first filter element 131, the second filter element 132, and the third filter element 133.

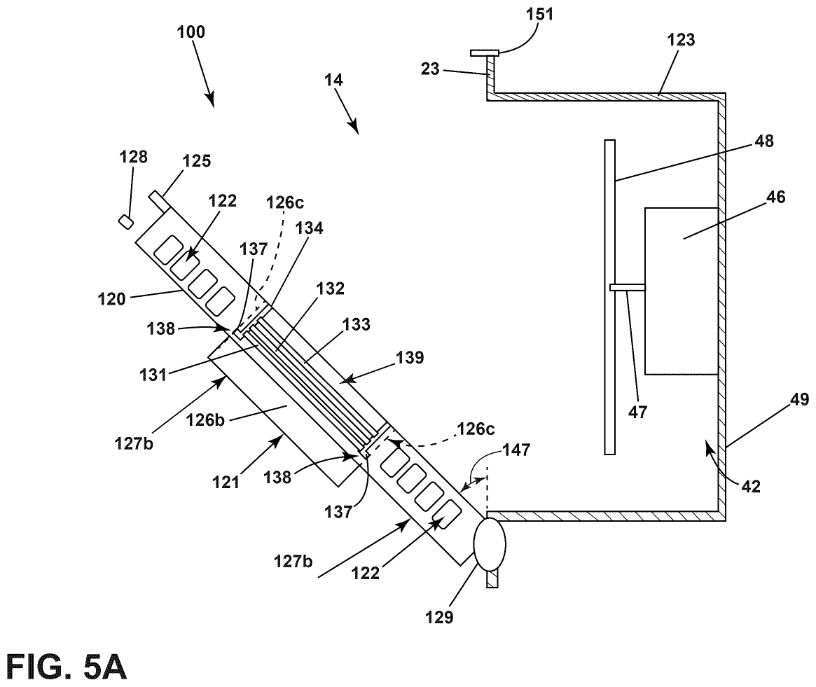

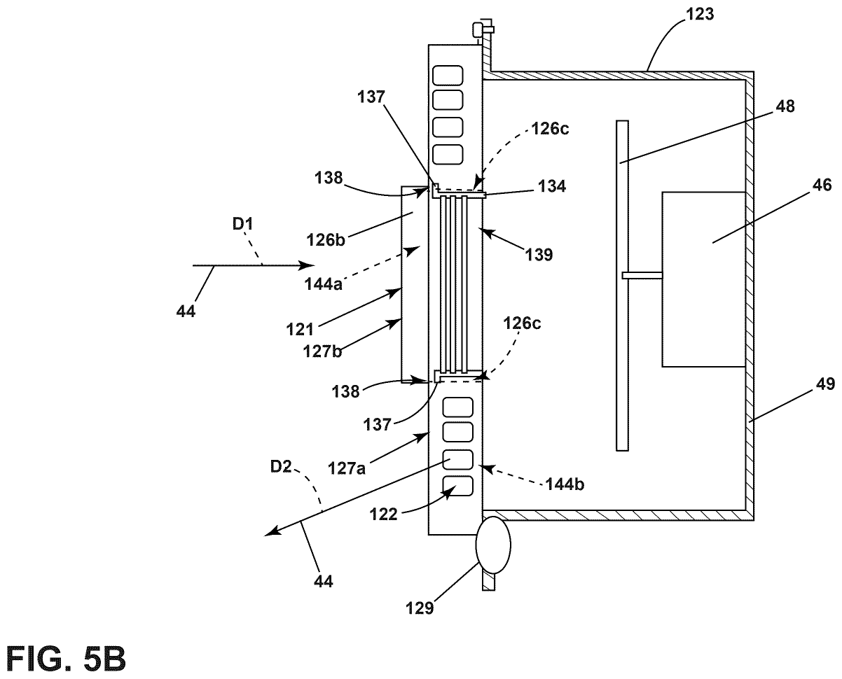

The baffle 120 can at least partially enclose the cartridge 139. The baffle 120 can be mounted or coupled (e.g., to the rear wall 23) in any suitable manner. In the illustrated example, the baffle 120 is selectively rotatable between the closed position (shown in FIG. 5B) and an opened position (shown in FIG. 5A). In the non-limiting example where the baffle 120 is rotatably mounted, the baffle 120 can include a hinge portion 129. When the baffle 120 is in the closed position (FIG. 5B), the baffle 120 can direct the airflow 44 while preventing manual access (e.g., by a user) to the filter casing 134 or cartridge 139, for example during a cooking operation. When the baffle 120 is in the opened position (FIG. 5A), the baffle 120 can enable manual access (e.g., by a user) to the filter casing 134 or cartridge 139, for example when servicing or replacing the filter stages 130.

The baffle 120 can include a base 125, a first wall 126a extending obliquely radially inward from the base 125 (e.g., toward cooking chamber 14), a second wall 126b, a third wall 126c, a first cover portion 127a, a second cover portion 127b. The first wall 126a can extend obliquely radially inward from the base 125 (e.g., toward cooking chamber 14) to the first cover portion 127a. The second wall 126b can extend obliquely radially inward from the first cover portion 127a (e.g., toward cooking chamber 14) to the second cover portion 127b. When the baffle 120 is the closed position (FIG. 5B), the second wall 126b can be aligned in registry with the set of filter stages 130 with respect to the airflow 44. The first cover portion 127a and second cover portion 127b can be substantially planar, parallel to each other, and spaced apart by the second wall 126b. The third wall 126c can extend obliquely radially outward (e.g., e.g., toward the convection fan 42) from the base 125. The second cover portion 127b can define a set of first apertures 121 sized and positioned to allow the airflow 44 in a first direction D1 therethrough. For example, the first direction D1 can be toward the convection fan 42. While the first apertures 121 are illustrated as substantially arcuate, other aspects are not so limited and the first apertures 121 can include any desired number of first apertures 121 having any desired geometric shape (e.g., circular, rectangular, etc.) or combination of shapes. The first wall 126a can further define a set of second apertures 122 sized and positioned to allow the airflow 44 in a second direction D2 therethrough. For example, the second direction D2 can be the cooking chamber 14. While the second apertures 122 are illustrated as substantially rectangular, other aspects are not so limited and the second apertures 122 can have any desired number of second apertures 122 having any desired geometric shape (e.g., circular, rectangular, etc.) or combination of shapes without departing from the scope of the disclosure.

The second wall 126b can be disposed between the set of first apertures 121 and the set of second apertures 122. In non-limiting aspects, the second wall 126b can be generally annular, and can circumferentially surround the set of first apertures 121. As such, the second wall 126b can at least partially define a first duct 144a.

When assembled, the third wall 126c can circumferentially surround the filter casing 134. The third wall 126c can be arranged to support the filter casing 134 and filter stages 130 in fluid communication with the first duct 144a. Additionally, the third wall 126c can comprise outer periphery 145 substantially parallel to and spaced from the first wall 126a. In non-limiting aspects, a second duct 144b can be cooperatively defined between the first wall 126a and the outer periphery 145 of the third wall 126c. The second duct can be in fluid communication with the first duct 144a to receive the airflow 44 therefrom.

It will be appreciated that the number, size and shape of the first apertures 121, second apertures 122, as well as the orientation of the first wall 126a, second wall 126b, third wall 126c, first duct 144a, and second duct 144b, and combinations thereof, can be arranged cooperatively with the convection fan 42 to enable a particular airflow speed, volume, and airflow direction D1, D2 for the airflow 44 within the cooking chamber 14.

In some aspects, the base 125 can define a set of third apertures 143 sized to receive a respective fastener such as a screw (not shown) therethrough. In non-limiting aspects, the screw can cooperate with a nut 128 to secure the baffle 120 to the rear wall 23 (FIG. 2).

In operation, the convection fan 42 can initiate or force the airflow 44 within the cooking chamber 14. The airflow 44 can be in the first direction D1 (e.g., toward the convection fan 42, and in the second direction D2 (e.g., toward the cooking chamber 14). Such an airflow 44 can, e.g., decrease the required cooking temperature for food items, decrease the amount of time needed to cook food items, or assist in cooking food items more evenly. For example, in one aspect, the airflow 44 can be drawn in the first direction D1 through the set of first apertures 121, through the first duct 144a, and through the filter stages 130 toward the convection fan 42 and then redirected in the second direction D2 by the convection fan 42 through the second duct 144b toward the second apertures 122 and into the cooking chamber 14.

FIG. 5A depicts a schematic cross-section of the air filter assembly 100 in the opened position, and FIG. 5B depicts a schematic cross-section of the air filter assembly 100 of FIG. 5A in the closed position. The convection heating element 45 is omitted for clarity. With simultaneous reference to FIGS. 5A and 5B, the motor 46 and convection element (shown in FIG. 4) can be connected to an energy source (not shown) and the controller 30 (shown in FIG. 2). In various non-limiting aspects (not shown), the blade assembly 48, or the air filter assembly 100, or both can extend into the cooking chamber 14 without departing from the scope of the disclosure. In a non-limiting example, an annular flange 123 can extend rearward from the rear wall 23 away from the cooking chamber 14. A support member 49 can be coupled to the annular flange 123. In non-limiting aspects, the motor 46 can be coupled to the support member 49.

The filter casing 134 can be removably coupled to the third wall 126c. It is contemplated that in non-limiting aspects, the third wall 126c can define a set of second retention features 138 to releasably engage the filter casing 134. For example, in non-limiting aspects, the set of second retention features 138 can be a set of slots or grooves. Each second retention features 138 can be complimentary and engageable with a respective first retention feature 137 of the filter casing 134 to couple the filter casing 134 to the baffle 120. In this way, the baffle 120 can limit or arrest an axial movement, a radial movement, or both, of the filter casing 134, the first filter element 131, the second filter element 132, and the third filter element 133. It is contemplated that the second retention features 138 can be arranged to require a rotation of the filter casing 134 to releasably capture the first retention features 137 within the second retention features 138. In other non-limiting aspects, the filter casing 134 can be coupled to the third wall 126c using conventional fasteners such as screws (not shown).

The hinge portion 129 of the baffle 120 can be coupled to the rear wall 23 of the cooking chamber 14 and configured to enable a selective rotation of the baffle 120 between the opened position (FIG. 5A) and the closed position (FIG. 5B). The opened position can define a predetermined angle 147 between the baffle 120 and the rear wall 23. It is contemplated that the filter casing 134 is readily removeable from the baffle 120 when the baffle 120 is in the opened position, for example for maintenance or periodic servicing of the first filter element 131, the second filter element 132, and the third filter element 133. For example, the filter casing 134 can be rotated or otherwise moved to disengage the first retention features 137 from the second retention features 138, and the filter casing 134 can be pulled or removed from the baffle 120.

When in the closed position (FIG. 5B), the baffle 120 can be attached to the rear wall 23 of the cooking chamber 14 via fasteners. For example, in non-limiting aspects, the baffle 120 can be affixed via a screw 151 and the nut 128 to shield or cover the air filter assembly 100 and convection fan 42. When in the closed position, the baffle 120 is in fluid communication with the convection fan 42 to receive the airflow 44 therethrough. For example, during an operation of the convection fan 42, the airflow 44 is directed in the first direction D1 through the set of first apertures 121 and through the air filter assembly 100. The convection fan 42 can further drive the airflow in the second direction through the set of second apertures 122 and into the cooking chamber 14.

In non-limiting aspects, the first filter element 131 can be substantially planar. The first filter element 131 can be a “pre-filter”, and can include a wire mesh filter element, for example configured to capture grease particles and smoke from the airflow 44. In non-limiting aspects, the second filter element 132 can be substantially planar. The second filter element 132 can include a high-efficiency particulate air filter (HEPA) element, for example configured to remove airborne particles with a size of 0.3 microns (μm) or greater from the airflow 44. In non-limiting aspects, the third filter element 133 can be substantially planar. The third filter element 133 can include an activated charcoal screen filter element for example to remove gases and odors from the airflow 44. It is contemplated that the filter assembly 100 can sustain temperatures of at least 360 degrees Celsius. In non-limiting aspects, the first filter element 131 can have a thickness (e.g., measured in the direction of D1 of between 10 millimeters (mm) and 25 mm. However, other aspects are not so limited and each of the first, second, and third filter elements 131, 132, 133 can have any desired thickness, including less than 120 mm or more than 25 mm without departing from the scope of the disclosure.

It will be understood that the filter stages 130 can be formed of any suitable filter media and that any suitable number of first, second, or third filter elements 131, 132, 133 can be included. The filter media can comprise one or a combination of suitable filter media types such as wire mesh, porous foam, paper, melt-blown nonwoven polymer, or pleated filter media, including HEPA, or combinations thereof, for example.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cooking appliance comprising:
a chassis defining a cooking chamber and having an access opening;
a heating element operably coupled with the cooking chamber;
a convection fan in fluid communication with the cooking chamber via an aperture defined in chassis; and
an air filter assembly in fluid communication with the convection fan, the air filter assembly comprising a hinged baffle disposed in the cooking chamber in fluid communication with the convection fan, and a set of filter stages positioned between the convection fan and the hinged baffle, wherein the hinged baffle is selectively moveable between a closed position and an opened position.

2. The cooking appliance of claim 1, wherein the air filter assembly includes a filter casing supporting and circumferentially surrounding the set of filter stages.

3. The cooking appliance of claim 2, wherein the filter casing is removably coupled to the hinged baffle.

4. The cooking appliance of claim 1, wherein the set of filter stages comprises a first filter element, a second filter element, and a third filter element.

5. The cooking appliance of claim 4, wherein the first filter element includes a wire mesh filter element, the second filter element includes a high-efficiency particulate air (HEPA) filter element, and the third filter element includes a charcoal screen filter element.

6. The cooking appliance of claim 1, wherein during an operation of the convection fan, an airflow is directed in a first direction through a first set of apertures defined through the hinged baffle and the set of filter stages toward the convection fan.

7. The cooking appliance of claim 6, wherein during the operation of the convection fan, the airflow is further directed in a second direction through a second set of apertures defined through the hinged baffle, and into the cooking chamber.

8. The cooking appliance of claim 2, wherein the filter casing includes a set of circumferentially spaced first retention features extending toward the cooking chamber.

9. The cooking appliance of claim 8, wherein the hinged baffle defines a set of second retention features sized to receive a respective first retention feature therein.

10. The cooking appliance of claim 1, wherein the hinged baffle is secured to a wall of the chassis via a fastener when the hinged baffle is in the closed position.

11. The cooking appliance of claim 1 wherein the heating element circumferentially surrounds the convection fan.

12. The cooking appliance of claim 1, wherein the convection fan is in fluid communication with the cooking chamber via the hinged baffle.

13. An air filter assembly for a cooking appliance having a chassis defining a cooking chamber, and a convection fan in fluid communication with the cooking chamber; the air filter assembly comprising:
a hinged baffle disposed in the cooking chamber and selectively moveable between a closed position in fluid communication with the convection fan, and an opened position; and
a set of filter stages positioned between the convection fan and the hinged baffle.

14. The air filter assembly of claim 13, further comprising a filter casing supporting and circumferentially surrounding the set of filter stages and removably coupled to the hinged baffle.

15. The air filter assembly of claim 13, wherein the set of filter stages comprises a first filter element, a second filter element, and a third filter element.

16. The air filter assembly of claim 15, wherein the first filter element includes a wire mesh filter element, the second filter element includes a HEPA filter element, and the third filter element includes a charcoal screen filter element.

17. The air filter assembly of claim 13, wherein during an operation of the convection fan, an airflow is directed in a first direction through a first set of apertures defined through the hinged baffle, and further directed in the first direction through the set of filter stages toward the convection fan.

18. The air filter assembly of claim 17, wherein during the operation of the convection fan, the airflow is further directed in a second direction through a second set of apertures defined through the hinged baffle, and further directed in the second direction into the cooking chamber.

19. The air filter assembly of claim 14, wherein the filter casing includes a set of circumferentially spaced first retention features extending toward the cooking chamber.

20. The air filter assembly of claim 17, wherein the hinged baffle defines a set of second retention features sized to receive a respective first retention feature therein.
